(19) United States
(12) Patent Application Publication
(10) Pub. No.: US 2017/0203925 A1
(43) Pub. Date: Jul. 20, 2017

(54) DUAL-BAND-MATERIAL CONVEYING DEVICE

(71) Applicant: CHENGDU HOMIN TECHNOLOGY CO., LTD, Chengdu (CN)

(72) Inventors: Junjie GUO, Chengdu (CN); Ke PENG, Chengdu (CN); Guofu TIAN, Chengdu (CN); Lin ZHAO, Chengdu (CN); Jian YOU, Chengdu (CN); Zhouyan WANG, Chengdu (CN); Liang YU, Chengdu (CN)

(73) Assignee: CHENGDU HOMIN TECHNOLOGY CO., LTD, Chengdu (CN)

(21) Appl. No.: 15/328,032

(22) PCT Filed: May 25, 2016
(86) PCT No.: PCT/CN2016/083231

§ 371 Date: Jan. 22, 2017

(30) Foreign Application Priority Data
May 28, 2015 (CN) 201510281433.3

(51) Int. Cl. B65G 25/04; B65G 45/18

(52) U.S. Cl. CPC B65G 25/04; B65G 45/18

(57) ABSTRACT

The present invention discloses a dual-band-material conveying device which comprises a material distributing device (4), a feeding device (5) and a conveying line (6). The material distributing device (4) comprises an adjusting plate (44), two limiting pillars (41) and a material distributing pillar (43). The adjusting plate (44) is mounted on the conveying line (6) through a mounting pillar (45), the adjusting plate (44) is provided with an adjusting groove (42) in which the two limiting pillars (41) and the material distributing pillar (43) are mounted. The conveying line (6) is provided with a pit, and the feeding device (5) is mounted in the pit. The feeding device (5) comprises a movable feeding device body (51), a fixed feeding device body (53) and two guide frames (54). The movable feeding device body (51) and the fixed feeding device body (53) are mounted between the two guide frames (54).

### CROSS REFERENCE TO RELATED APPLICATIONS

This application is the national phase entry of International Application No. PCT/CN2016/083231, filed on May 25, 2016, which is based upon and claims priority to Chinese Patent Application No. 201510281433.3 filed on May 28, 2015, the entire contents of which are incorporated herein by reference.

### TECHNICAL FIELD

The present invention relates to a feeding device, in particular to a dual-band-material conveying device.

### BACKGROUND ART

A feeding device under the conditions of the prior art: only can realize conveying of single sheet material when used for conveying sheet materials, and thus can only supply single-line production. It is necessary to start appropriate production lines respectively when many kinds of sheet materials are processed. Correspondingly, it is necessary to arrange multiple sets of different feeding devices, which causes low production efficiency, high energy consumption, long auxiliary time and other problems.

### SUMMARY OF INVENTION

### Technical Problem

The present invention aims to overcome the defects of the prior art and provides a dual-band-material conveying device which is convenient to use and high in conveying efficiency. This device may realize conveying of two metal band materials of different materials, thicknesses and widths, and is simple in structure and convenient to use.

### Solution to the Problem

### Technical Solution

The objective of the present invention is realized by the following technical solution: a dual-band-material conveying device comprises a material distributing device, a feeding device and a conveying line, wherein the material distributing device comprises an adjusting plate, two limiting pillars and a material distributing pillar; the adjusting plate is mounted on the conveying line through a mounting pillar, the adjusting plate is provided with an adjusting groove, and the two limiting pillars and the material distributing pillar are mounted in the adjusting groove; the conveying line is provided with a pit, and the feeding device is mounted in the pit; the feeding device comprises a movable feeding device body, a fixed feeding device body and two guide frames; the movable feeding device body and the fixed feeding device body are mounted between the two guide frames; each guide frame is provided with a sliding chute; the movable feeding device body is provided with two guide blocks which are mounted in the sliding chutes; an air cylinder is mounted above the movable feeding device body; the movable feeding device body is internally provided with a pressing plate groove; a pressing plate is mounted on a piston rod of the air cylinder and is located in the pressing plate groove; in the same way, an air cylinder is mounted above the fixed feeding device body, the fixed feeding device body is internally provided with a pressing plate groove, a pressing plate is mounted on a piston rod of the air cylinder, and the pressing plate is located in the pressing plate groove; and according to a feeding direction, the material distributing device is mounted behind the feeding device.

A cleaning device is mounted behind the material distributing device and comprises a compression nut, two adjusting rods and a hairbrush plate, wherein the two adjusting rods are mounted on two sides of the conveying line, the hairbrush plate is mounted on the two adjusting rods, a spring is mounted on the two adjusting rods and located above the hairbrush plate, and the compression nut is arranged above the hairbrush plate, and a hairbrush is mounted below the hairbrush plate.

A detecting device is mounted behind the cleaning device and arranged on the conveying line, and a detector is mourned below the detecting device.

A rolling wheel device is arranged behind the detecting device and comprises two support frames, a rolling shaft mounted between the two support frames and rolling wheels mounted on the rolling shaft, and the two support frames are mounted on two sides of the conveying line.

The bottom of the pressing plate groove and the topmost position of the conveying line are on the same horizontal plane.

The thickness of the guide block is the same as the height of the sliding chute.

### Beneficial Effects of the Invention

### Beneficial Effects

The present invention has the following advantages:

1. The device can be used for simultaneous feeding of many kinds of band blanks, such that the working efficiency is high, the processing cycle and the auxiliary time can be shortened, and the labor intensity can be relieved for workers;

2. the air cylinder is used to control pressing of the pressing plate, such that the pressing plate is flexible and rapid in response and reliable in pressing, and can be used to press multiple blanks of different thicknesses, and therefore, the application range of equipment is expanded;

3, sundries and burrs on surfaces of the blanks can be removed by the cleaning device to protect the surfaces of equipment and the blanks from being damaged;

4, a feeding route of the blanks is limited by the material distributing device, such that subsequent processing precision can be ensured; and

5. the movable feeding device body and the fixed feeding device body are arranged to finish feeding of the blanks, and therefore the device has the advantages of flexibility in control, convenience in operation, high precision and the like.

### BRIEF DESCRIPTION OF THE DRAWINGS

### Description of the Drawings

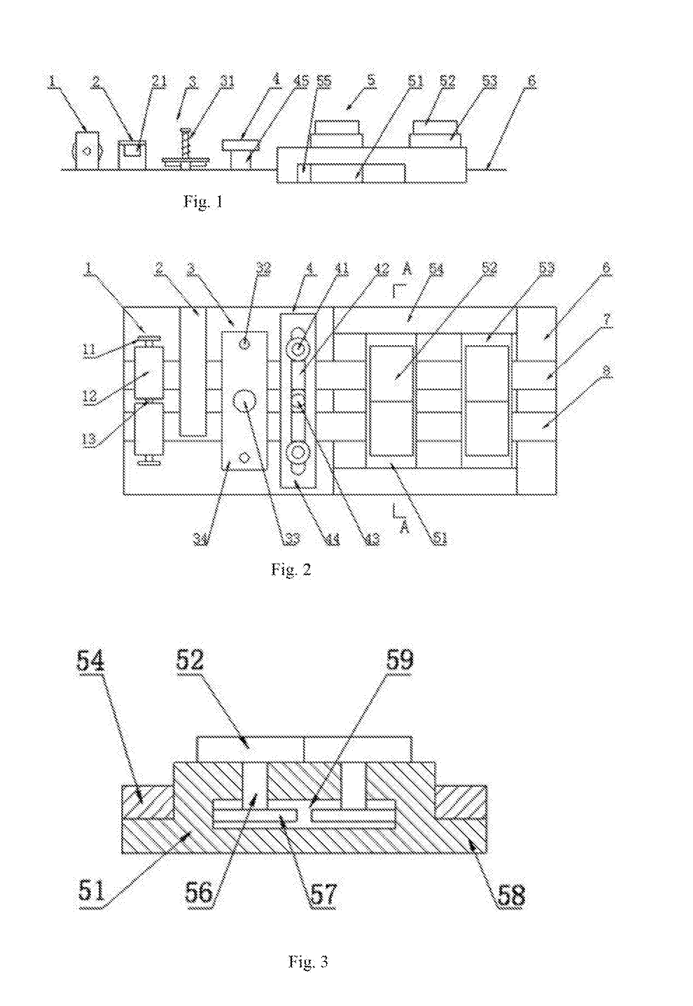

FIG. 1 is a structural schematic drawing of the dual-band-material conveying device;

FIG. 2 is a top view of a dual-band-material conveying device; and

FIG. 3 is an A-direction sectional view of a dual-band-material conveying device.

In drawings, rolling wheel device 1, support frame 11, rolling wheel 12, rolling shaft 13, detecting device 2, detector 21, cleaning device 3, spring 31, adjusting rod 32, compression nut 33, hairbrush plate 34, material distributing device 4, limiting pillar 41, adjusting groove 42, material distributing pillar 43, adjusting plate 44, mounting pillar 45, feeding device 5, movable feeding device body 51, air cylinder 52, fixed feeding device body 53, guide frame 54, sliding chute 55, piston rod 56, pressing plate 57, guide block 58, pressing plate groove 59, conveying line 6, metal bank material A 7 and metal band material B 8 are marked.

### DETAILED DESCRIPTION OF INVENTION

### Implementations of the Invention

The present invention will be further described as below in conjunction with the drawings. The protection scope of the present invention is not limited to the following content:

as shown in FIG. 1 and FIG. 2, a dual-band-material conveying device comprises material distributing device 4, feeding device 5 and conveying line 6, wherein material distributing device 4 comprises adjusting plate 44, two limiting pillars 41 and material distributing pillar 43; adjusting plate 44 is mounted on conveying line 6 through mounting pillar 45, adjusting plate 44 is provided with adjusting groove 42, and two limiting pillars 41 and material distributing pillar 43 are mounted in adjusting groove 42. Two different band blanks are respectively limited on appropriate feeding routes under the limiting and guiding effects of two limiting pillars 41 and material distributing pillar 43 so as to ensure the processing precision;

conveying line is provided with a pit, and feeding device 5 is mounted in the pit;

as shown in FIG. 3, feeding device 5 comprises movable feeding device body 51, fixed feeding device body 53 and two guide frames 54, wherein movable feeding device body 51 and fixed feeding device body 53 are mounted between two guide frames 54; each guide frame 54 is provided with sliding chute 55; movable feeding device body 51 is provided with two guide blocks 58 which are mounted in sliding chutes 55. In this embodiment, the thickness of guide block 58 is the same as the height of sliding chute 55. Air cylinder 52 is mounted below movable feeding device body 51, movable feeding device body 51 is additionally connected to air cylinder which moves upwards in a horizontal direction thereof, and therefore, movable feeding device 51 can slide between two guide frames 54. Under the constraint of sliding chutes 55, movable feeding device body 51 can only reciprocate within a certain range. Movable feeding device body 51 is internally provided with pressing plate groove 9. In this embodiment, the bottom of pressing plate groove 59 and the topmost position of conveying line 6 are on the same horizontal plane. Pressing plate 57 is mounted in piston rod 56 of air cylinder 52, and pressing plate 57 is located in pressing plate groove 59. In the same way, air cylinder 52 is mounted above fixed feeding device body 53, fixed feeding device body 53 is provided with pressing plate groove 59, pressing plate 57 is mounted on piston rod 56 of air cylinder 52, and pressing plate 57 is located in pressing plate groove 59. Fixed feeding device 53 is fixedly mounted between two guide frames 54. According to a feeding direction, material distributing device 4 is mounted behind feeding device 5.

A cleaning device 3 is mounted behind material distributing device 4 and comprises compression nut 33, two adjusting rods 32 and hairbrush plate 34, wherein two adjusting rods 32 are mounted on two sides of conveying line 6, hairbrush plate 34 is mounted on two adjusting rods 32, spring 31 is mounted on two adjusting rods 32 and located above hairbrush plate 34, and compression nut 3 is arranged above hairbrush plate 34, and hairbrush is arranged below hairbrush plate 34. The height of hairbrush plate 34 can be adjusted by compression nut 33, such that a distance between the hairbrush and the surface of a blank piece can be adjusted, and the surface of fur can be prevented from being scraped. The angle of hairbrush plate 34 can be finely tuned by spring 31 according to the thickness of the blank piece so as to adapt to blanks of different thicknesses.

A detecting device 2 is mounted behind cleaning device 3 and arranged on conveying line 6, and detector 21 is mounted below detecting device 2. The detector 21 is configured to detect whether blanks are conveyed, and if not, transfer a signal to a signal processing device, and then the signal processing device gives an alarm to inform workers to add blanks and shut down equipment to avoid idling,

A rolling wheel device 1 is mounted behind detecting device 2 and comprises two support frames 11, rolling shaft 13 mounted between two support frames 11 and rolling wheels 1 mounted on rolling shaft 13, wherein two support frames 11 are mounted on two sides of conveying line 6. Rolling wheels 12 can rotate feely on rolling shaft 13 and are made of an elastic material. The diameter of each rolling wheel can be selected according to the thickness of the blanks. When the blanks pass through a position below rolling wheels 12, warped blanks can be pressed down under the extrusion effect of rolling wheels 12 to ensure that the blanks are always clung to conveying line 6, thereby ensuring the processing precision.

A working process of present invention is as follows: existing two different band blanks, namely metal band material 7 and metal band material 8 which are different in thickness, material and width enter conveying line 6 simultaneously through rolling wheel device 1, and metal band material 7 and metal band material 8 can be prevented from being warped under the extrusion effect of rolling wheels 12; then, metal band material 7 and metal band material 8 pass through detecting device 2 and cleaning device 3 by clinging to conveying line 6, such that the surfaces of metal band material 7 and metal band material 8 are cleaned and burrs on the edges thereof are removed by the hairbrush inside cleaning device 3; later, metal band material 7 and metal band material 8 pass through a clearance between two limiting pillars 41 and material distributing pillar 43 and are clamped by movable feeding device body 51, movable feeding device body 51 is controlled to move toward fixed feeding device body 53 under the driving of the air cylinder moving in a horizontal direction, and at this moment, pressing plate 57 of fixed feeding device body 53 does not contact metal band material 7 and metal band material 8; metal band material 7 and metal band material 8 are clamped by movable feeding device body 51 to move forwards; when movable feeding device body 51 moves one station forwards, pressing plate 57 of fixed feeding device body 53 contacts and presses metal band material 7 and metal band material 8; and pressing plate 57 of movable feeding device body 51 is separated from metal band material 7 and metal band material 8 and the moves one station in a direction away from fixed feeding device body 53 under the action of the air cylinder which controls movable feeding device body 51 to move in a horizontal direction, and by this point, once feeding is finished.

What is claimed is:

1. A dual-band-material conveying device, comprising:
a material distributing device, a feeding device and a conveying line, wherein the material distributing device comprises an adjusting plate, two limiting pillars and a material distributing pillar; wherein the adjusting plate is mounted on the conveying line through a mounting pillar, the adjusting plate is provided with an adjusting groove, and the two limiting pillars and the material distributing pillar are mounted in the adjusting groove; the conveying line is provided with a pit, and the feeding device is mounted in the pit; wherein the feeding device comprises a movable feeding device body, a fixed feeding device body and two guide frames; the movable feeding device body and the fixed feeding device body are mounted between the two guide frames; each of the two guide frames is provided with a sliding chute; the movable feeding device body is provided with two guide blocks which are mounted in the sliding chute; an air cylinder is mounted above the movable feeding device body; the movable feeding device body is internally provided with a pressing plate groove; a pressing plate is mounted on a piston rod of the air cylinder and is located in the pressing plate groove; in the same way, the air cylinder is mounted above the fixed feeding device body, the fixed feeding device body is internally provided with the pressing plate groove, the pressing plate is mounted on the piston rod of the air cylinder, and the pressing plate is located in the pressing plate groove; and according to a feeding direction, the material distributing device is mounted behind the feeding device.

2. The dual-band-material conveying device according to claim 1, wherein a cleaning device is mounted behind the material distributing device and comprises a compression nut, two adjusting rods and a hairbrush plate, wherein the two adjusting rods are mounted on two sides of the conveying line, the hairbrush plate is mounted on the two adjusting rods, a spring is mounted on the two adjusting rods and located above the hairbrush plate, the compression nut is arranged above the hairbrush plate, and a hairbrush is mounted below the hairbrush plate.

3. The dual-band-material conveying device according to claim 1, wherein a detecting device is mounted behind a cleaning device and arranged on the conveying line, and a detector is mounted below the detecting device

4. The dual-band-material conveying device according to claim 1,
wherein a rolling wheel device is arranged behind a detecting device and comprises two support frames, a rolling shaft mounted between the two support frames and rolling wheels mounted on the rolling shaft, and the two support frames are mourned on two sides of the conveying line.

5. The dual-band-material conveying device according to claim 1, wherein a bottom of the pressing plate groove and a topmost position of the conveying line are on a same horizontal plane.

6. The dual-band-material conveying device according to claim 1, wherein a thickness of each of the two guide blocks is the same as a height of the sliding chute.
